(19) United States
(12) Patent Application Publication
(10) Pub. No.: US 2015/0356493 A1
(43) Pub. Date: Dec. 10, 2015

(54) System and Method of Managing a Schedule

(71) Applicants: Bobby Valdus Skujins, Richmond (CA); Siavash Dabiri, North Vancouver (CA)

(72) Inventors: Bobby Valdus Skujins, Richmond (CA); Siavash Dabiri, North Vancouver (CA)

(21) Appl. No.: 14/324,995

(22) Filed: Jul. 7, 2014

Related U.S. Application Data
(63) Continuation-in-part of application No. 14/298,372, filed on Jun. 6, 2014.

(51) Int. Cl. G06Q 10/06; H04W 4/02

(52) U.S. Cl. CPC G06Q 10/063114; H04W 4/02

(57) ABSTRACT

A system and method is provided whereby a central control computer receives work assignment information, processes the information, transmits work schedules to employees, and updates schedules based on job status and travel time between work sites.

### INDEX TO RELATED APPLICATIONS

This application is a continuation-in-part of U.S. patent application Ser. No. 14/298,372 filed Jun. 6, 2014 the disclosure of which is incorporated herein by reference in its entirety.

### BACKGROUND OF THE INVENTION

The management of persons dispatched for assigned duties is often difficult. A schedule administrator is tasked with efficiently monitoring and implementing the tasks and must account for travel time and task completion time. Often, the time periods are not accurately tracked. The present invention addresses these activities.

### SUMMARY OF THE INVENTION

A Customer Relationship Management (CRM) scheduling system of the present invention provides schedules, keeps track of daily jobs, and organizes the employee's day. Specifically, time in an appointment and, more importantly, driving directions including travel time allotment, allowing for rush hour traffic delays, or slower time periods.

The system and method assigns employees jobs from the web portal to each employee's app. The app will calculate travel time to and from each “job” and the job's duration time, essentially calculating and planning the whole day for the employee. The system and method includes an app with easy one click access to make phone calls to the client and access to Global Positioning Satellite (GPS) showing the directions to their destination. As the jobs are being approached, the job time recordation feature will automatically start. After the job is done, the employee then will mark complete on that job and then follow his/her schedule on her app to his/her next appointment. All the starts, completes, notes made during the job, and moving a assignment to another day is automatically updated in the web portal that is controlled by the office management.

All the jobs that are assigned are automatically put in the logbook on the web portal that can be search by any description of the job.

A management system used for scheduling staff appointments. The system has two primary human interface parts:
1) Web interface—user administrator will only have access to this online web portal (server-based) using a unique password to manage staff members and appointments for any given day.
2) Smart hand-held device app—Each staff member is granted a unique password to access his/her appointments on any day of any calendar year via their smart hand-held device.

The user administrator can assign different appointments to each staff member's schedule. This can be done by simply dragging appointments and dropping them on each staff members' schedule. Once an appointment is added to a staff member, a notification will be sent to that specific staff members' smart hand-held device to notify him/her that a new appointment has been added to his/her schedule. Any staff member can also add appointments to their own schedule. Every user can set their start of day/time and re-order the appointments for that day. Based on the start-of-the-day time, estimated duration for each meeting (set by whoever who added the job to the schedule), and the appointment addresses provided for each appointment on that day, using GPS tracking system of his/her smart hand-held device and simple calculations, the estimated arrival time for every meeting on that date is calculated and displayed. A staff member can also use GPS tracking system built-in the app itself to navigate to his/her next scheduled meetings. This will eliminate the manual information entry by the user for the GPS because all the information about the routing is used from the app itself. This will encourage efficient and safe traveling for the staff members.

The user administrator also keeps track of all the distance travelled by each staff member each month using the GPS tracking system on his/her small hand-held device. This information can be user to calculate the mileage cost, for example, of each month per staff member.

The system will automatically notify the user administrator that any staff member has arrived to his/her appointment, using GPS tracking system of his/her smart hand-held device. Once the staff member has finished their appointment, they will manually notify the system that they have finished their appointment and the user administrator will be notified. This feature will help the user administrator to track each staff member's progress through his/her schedule everyday.

At a pre-adjustable time every day, all the unfinished appointments will be added to the “unfinished” appointment folder/queue on the server and the user administrator will be able to assign them to any of the staff members. The user administrator can also send general notification to all the staff members' smart hand-held devices at once from the web portal to make general “announcements”.

History of all the jobs will be saved on the server. Every staff member is capable of adding comments and any other types of information related to their clients meetings and it will be saved on the server along with the appointment. A user administrator will be able to access the schedules for any day of any year, including the notes/other information left by the staff member (on past appointments) who was assigned to that job. Each appointment on the server is selectively searchable by any one or combination of address, name, phone number, email, and the staff member names (who completed that appointment).

In one embodiment, the present invention is a system for management of employee schedules, data management, and assignments comprising:

a program stored on a non-transitory computer readable medium and at least one control computer operatively associated with said program;
a compiling process whereby individual job requests from an input are compiled into a system management schedule;
a schedule assignment process implemented by said program whereby said process receives input including at least one of a customer name, a customer address, information about a customer job, or combinations thereof;
at least one device constructed and arranged for receiving individualized work schedule assignments from said schedule assignment process, said device further having configuration for communication with said computer operatively associated with said program; and
recordation of distance traveled by an individual completing at least one assignment, whereby said recordation is selectively output to said control computer, said at least one device, or combinations thereof.

The control computer is, in one embodiment, a computer accessed and operated in some supervisory capacity such as a scheduling supervisor, work supervisor, manager, third party scheduler and the like.

The device constructed and arranged for receiving individualized work schedule assignments is any of a cell phone, smart phone, tablet, laptop, or any mobile computing device.

The system device for receiving individualized work schedule includes a GPS tracking element that transmits location information from said device to said control computer.

The control computer is configured with a schedule adjustment process whereby work schedules are adjusted depending on work task duration and travel time between work task locations.

In one embodiment, the present invention is a method of managing assigned tasks said method comprising the steps of:

providing a system as taught by the present invention;
inputting a work task into said system;
assigning said work task to an individual; and
transmitting said work task to said individual.

The method includes the step of transmitting location information of said individual to said system and transmitting job status information to the system.

The method also includes the step of reconfiguring a daily work schedule based on system input relating to job status, job location, distance traveled, or combinations thereof.

### BRIEF DESCRIPTION OF THE SEVERAL VIEWS OF THE DRAWINGS

FIG. 1 is part 1 of a flow chart of the process of the present invention.

FIG. 2 is a continuation of the flow chart from FIG. 1.

FIG. 3 is a schematic of the components in the system of the present invention.

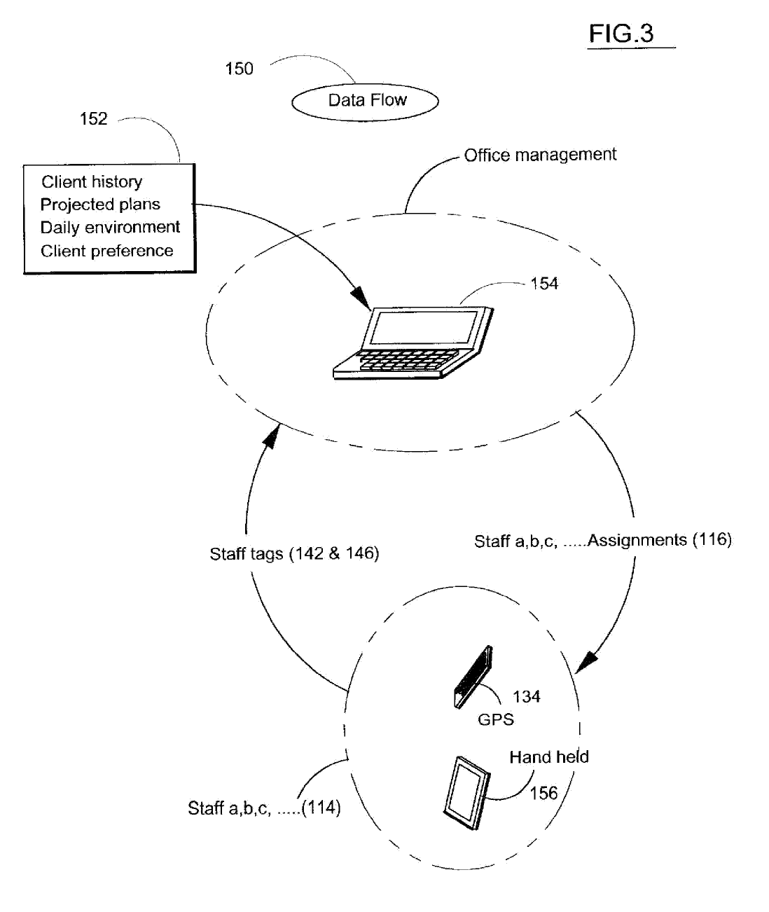

### DETAILED DESCRIPTION OF THE PREFERRED EMBODIMENT

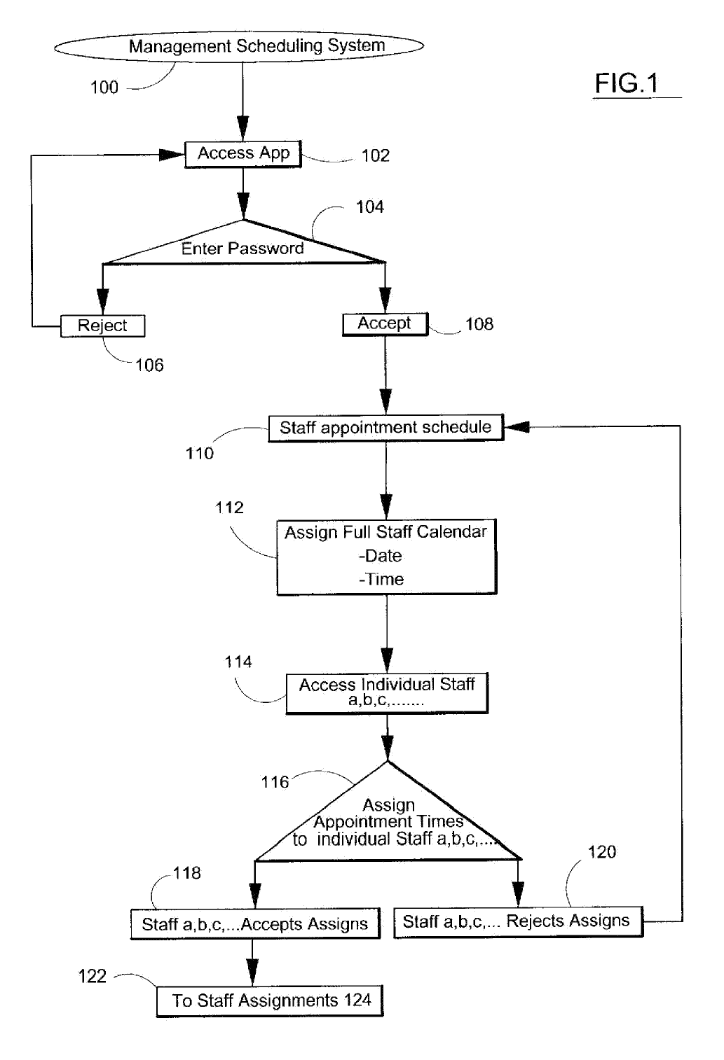

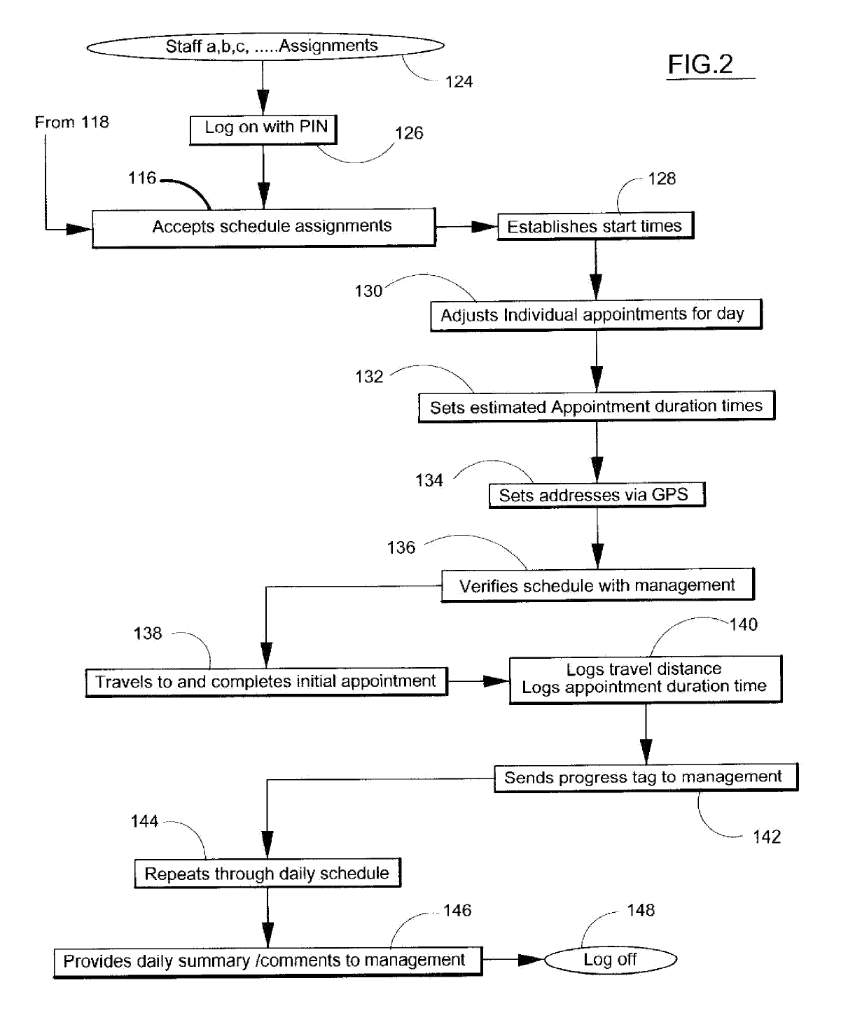

As generally understood and demonstrated in steps set forth on FIGS. 1 and 2, management scheduling system 100 includes a component in which it is operatively associated with an access app 102. Password 104 is required in order to access system 100. An incorrect password triggers a rejection 106 and returns to access 102 login page. A correct password is accepted 108 and accesses the staff appointment schedule 110. Schedule 110 is configurable by user to assign a full staff calendar 112. Subsequent to full staff calendar 112 is a feature whereby individual staff scheduling 114 is provided. Individual scheduling 114 is user configurable to assign individual appointment times 116 to particular staff. If, for some reason a staff member rejects an assigned appointment, the rejected appointment is returned to the master staff appointment schedule 110 and set for rescheduling. If a staff member accepts the assignment 118, the accepted assignment is processed to staff assignment register 122. As demonstrated in FIG. 2, a staff member logs in 126 and accepts schedule assignments in the schedule acceptor 116. The system then provides for the establishment of start times 128 scheduling of individual appointments on a daily basis 130 and setting approximate appointment duration times 132 populating addresses via global position satellite 134 and verifying an individual schedule with management 136. The staff member then travels to and completes an appointment 138 logs travel distance and import them in time one $0.40 progress to the system and management 142 and continues through daily schedule 144 providing daily summary to management 146 before ultimately logging off 148.

The data flow of the system of the present invention is set forth whereby dataflow 150 includes at least one of data indicators 152 including client history, projected plans, daily environment, client preferences, that is operatively associated with a system management device 154 whereby the database is in operative communication to provide staff assignments 116 to staff 114 via either a GPS device 134 a handheld tablet computing device 156 or combinations thereof. The staff sends progress tags 142 and 146 back to the system management device 154 thus completing the flow of information.

The system and method of the present invention is configured in order to optimize the assignment and execution of scheduled tasks as well as monitoring status and completion of tasks while taking into account variables such as length of task and travel time between scheduled appointments.

The system and method of the present invention provides greater planning and execution of worksite assignments.

In a preferred embodiment, one functional feature of the management system and method of the present invention is the ability to keep track of the total distance traveled by each staff member per job. This information can then be analyzed and used in many ways such as: billing the jobs based on the total number of distance traveled, staff pay based on the traveled distance, and other accounting purposes. The information is also exportable from the portal into any application, including, but not limited to, in excel type file format. Information is further selectively sortable for analysis in order to optimize business efficiency and operation.

In one embodiment, the system of the present invention has a distance tracking functionality that is selectively configurable to automatically collect each staffs' travelled distance. The selective configurability includes ability to administrative staff to sort and use this data as desired for planning and optimization. In one use, the data is evaluated to improve accounting efficiency; for example, automatically collects the total travelled distance for all staff members that work on specific project and put that towards the expenses for that project automatically. This can dramatically speed up the accounting process to bill the customer. Another example is to use the total travelled distance of all the office staff members throughout the whole year to file for annual taxes.

In one embodiment, the system that is on each staff members' hand-held device is automatically activated once the staff member hand-held device is synced with his/her automobile car via Bluetooth or other applicable technology. Once synced, the system automatically collects the total travelled distance, which is synced to the administrator portal workstation. When the staff member arrives at an appointment and leaves the car, the system recognizes that the staff member has arrived at job site, since the Bluetooth connection is lost. The system dynamically collects and stores this data on the administrative portal so the administrator can access this information dynamically, as required. The distance counted goes towards each appointment on a particular route. Data collected then can be viewed, sorted and/or output selectively in various formats such as (but not limited to): total distance traveled per staff member per month/year/week/etc., year, job, total distance per job that is travelled by all staff members that were working on that job, total distance travelled by all staff members per month/year/week/etc. All the data is saved and back-up automatically. If the Bluetooth technology is not available to the user, the user can manually enable the system to collect the total travelled distance, and the user can similarly deactivate the system manually by pressing a button on the hand-held device app to stop the system from continuing the collection of travelled distance. In a case where a user deactivates, the administrative portal is notified so as to prevent unauthorized travel during work hours.

The following is illustrative and a non-limiting example:

### Example

Employee 1 assigned to 3 jobs.

Employee 1 Handheld device is activated to synch with the portal upon start of his/her day.

Once Employee 1 sits in his car, his/her hand-held device is synched to the car Bluetooth and starts collecting travel distance. Employee 1 travels 9.4 km to first job. (Alternatively the distance collection system can be activated/deactivated manually by pressing a button in the software)

Employee 1 then travels 1.6 km to wholesale market to pick up some material.

Employee 1 then travels 2.3 km to second job.

Employee 1 then travels 0.5 km to wholesale market to pick up some material.

Employee 1 then travels 2.7 km to third job.

Employee 1 then travels 2 km back to the office.

End of day . . . .

Administrator receives data from Employee 1.

Administrator selects data for reports.

Report 1 is total distance traveled by Employee 1 for past month/year/week/etc.

Report 2 is total distance traveled by all employees assigned to that specific job for past month/year/week/etc.

Report 3 is calculated expenses payable for Employee 1 for the total distance travelled for past month/year/week/etc.

Report 4 is total distance travelled by all employees in past and current year and the total expenses payable for that amount of travelled distance.

Report 5 etc.

While the invention has been described in its preferred form or embodiment with some degree of particularity, it is understood that this description has been given only by way of example and that numerous changes in the details of construction, fabrication, and use, including the combination and arrangement of parts, may be made without departing from the spirit and scope of the invention.

What is claimed:

1. A system for management of employee schedules and assignments comprising:
a program stored on a non-transitory computer readable medium and at least one control computer operatively associated with said program;
a compiling process whereby individual job requests from an input are compiled into a system management schedule;
a schedule assignment process implemented by said program whereby said process receives input including at least one of a customer name, a customer address, information about a customer job, or combinations thereof;
at least one device constructed and arranged for receiving individualized work schedule assignments from said schedule assignment process, said device further having configuration for communication with said computer operatively associated with said program;
recordation of distance traveled by an individual completing at least one assignment, whereby said recordation is selectively output to said control computer, said at least one device, or combinations thereof; and
selectively output a report including at least one of: total distance traveled by said individual per month, per year, per week, per job, or combinations thereof; total distance per month, per year, per week, per job, or combinations thereof travelled by at least two individuals working on a single job; total distance traveled per month, per year, per week, per job, or combinations thereof travelled by all individuals in an organization utilizing the device constructed and arranged for receiving individualized work schedule assignments from said schedule assignment process.

2. The system of claim 1 whereby said device for receiving individualized work schedule includes a GPS tracking element that transmits location information from said device to said control computer.

3. The control computer of claim 1 further comprising a schedule adjustment process whereby work schedules are adjusted depending on work task duration and travel time between work task locations.

4. A method of managing assigned tasks said method comprising the steps of:
providing a system of claim 1;
inputting a work task into said system;
assigning said work task to an individual; and
transmitting said work task to said individual.

5. The method of claim 4 further comprising the step of transmitting location information of said individual to said system.

6. The method of claim 4 further comprising the step of transmitting job status information to said system.

7. The method of claim 4 further comprising the step of reconfiguring a daily work schedule based on system input relating to job status, job location, distance traveled or combinations thereof.
